(19) United States
(12) Patent Application Publication
(10) Pub. No.: US 2013/0001838 A1
(43) Pub. Date: Jan. 3, 2013

(54) CHARCOAL-CONTAINING PLASTIC PACKING MATERIAL AND METHOD FOR MANUFACTURING SAME

(76) Inventor: Haeng Su Park, Yongin-si (KR)

(21) Appl. No.: 13/634,472

(22) PCT Filed: Apr. 15, 2010
(86) PCT No.: PCT/KR10/02345

§ 371 Date: Sep. 12, 2012

(30) Foreign Application Priority Data
Apr. 13, 2010 (KR) 10-2010-0033784

(51) Int. Cl. B29C 49/04

(52) U.S. Cl. 264/555

(57) ABSTRACT

Disclosed are a charcoal-containing plastic packing material and a method for manufacturing the same. The present invention provides a plastic packing material which resolves the problems caused by the deficiency of compatibility between charcoal and resin such as deficiencies in mechanical properties, an aggregation phenomenon, foreign body sensation, defective forms, and poor quality, and which not only exhibits high-level general qualities, but which also, as a result of containing charcoal, has functional properties such as suppressing putrefactive bacteria, absorbing polluted particles and smells, radiating far-infrared rays and anions, and preventing the generation of static electricity. Also, the present invention provides a method for manufacturing a plastic packing material, in which the particle size, the amount used for resin, and the particle size uniformity of charcoal powder to be mixed with resin are adjusted according to the thickness of the plastic packing material to be formed.

### CROSS-REFERENCE TO RELATED APPLICATION

This application claims the benefit of Korean Patent Application No. 10-2010-0033784, filed Apr. 13, 2010, the disclosure of which is hereby incorporated herein by reference in its entirety.

### BACKGROUND OF THE INVENTION

1. Field of the Invention

An aspect of the present invention relates to a plastic packing material containing a functional substance, and more particularly, to a charcoal-containing plastic packing material and a method for manufacturing the same.

2. Description of the Related Art

These days, plastic packing materials are widely used as packing materials because of properties suitable for the packing materials, such as lightweight and sealing performance, excellent workability, economical efficiency, and the like.

Recently, attempts have been made to add not only a simple packing function but also functional properties of suppressing putrefaction of contents (food, etc.), preserving the degree of freshness, and the like to the plastic packing materials. For example, a method of making fine pores in a film and a method of containing several functional substances (e.g., inorganic substance, mineral, charcoal powder, aroma chemical, etc.) in a film are attempted so as to preserve the degree of freshness of contents (food, etc.) for a long period of time.

Among these functional substances, the charcoal powder attracts public attention because of several advantages of suppressing putrefactive bacteria, absorbing polluted particles and smells, radiating far-infrared rays and anions, and preventing the generation of static electricity. Korean Patent No. 10-0302957 discloses a method for manufacturing a charcoal-containing plastic container by mixing charcoal powder having a particle size of 20 μm or less at a volume ratio of 1 to 40% with polyethylene or polypropylene resin so as to produce a pallet-type chip and then performing injecting or blow molding using the chip as a raw material. Korean Patent No. 10-0828585 discloses a method for manufacturing film-type vinyl by grinding charcoal to charcoal powder having a particle size of about 500 to 4000 mesh, mixing resin and dispersing agent with the charcoal powder, removing moisture from the mixture so as to form a chip and then performing extrusion molding on the chip. Korean Patent No. 10-0623495 discloses a method for manufacturing a vinyl film by grinding yellow earth and charcoal to yellow earth and charcoal powder, mixing the powder and dispersing agent with resin so as to form a chip and then mixing the chip with resin and other additives.

However, if a charcoal-containing packing material is formed using plastic resin as a raw material, there occurs a problem of poor quality, such as the occurrence of tear on an interface between charcoal powder particles and polymer resin, the occurrence of defective forms, or the concentration of charcoal powder on a specific part due to the degradation of mobility of melting resin. The problem results from that the compatibility between the charcoal powder and the plastic resin is poor because the bulk density of the charcoal powder is about 0.3 as a hydrophilic material of which inside has a porous structure but the bulk density of the plastic resin is about 0.9 to 1.2 as a hydrophobic material having high viscosity. Therefore, the charcoal powder cannot be uniformly dispersed in the plastic resin using a method of simply mixing the two materials. Korean Patent No. 10-0302957 is a prior invention of the present applicant, which considerably resolves such a problem by powdering the charcoal mixed with the resin to have a particle size of 20 μm or less, and particularly resolves the problem that pores are produced due to the content of the charcoal. However, in spite of the method in Korean Patent No. 10-0302957, the problem cause due to the deficiency of the compatibility between the charcoal and the resin still remains, and particularly, the problem of poor quality, such as the occurrence of tear on an interface between charcoal powder particles and polymer resin, the occurrence of defective forms, or the concentration of charcoal powder on a specific part due to the degradation of mobility of melting resin still remains. The problems remarkably appear in film-type vinyl.

The present inventors have found that the problems appear different depending on the thickness of a plastic packing material to be formed, in the process of resolving the problems caused by the deficiency of compatibility between charcoal and resin such as deficiencies in mechanical properties, an aggregation phenomenon (foreign body sensation), defective forms, and poor quality. The present inventors have further found that the problem caused by the deficiency of compatibility between the charcoal and the resin can be resolved by adjusting the particle size, the amount used for resin, and the particle size uniformity of charcoal powder to be mixed with resin according to the thickness of the plastic packing material to be formed. Accordingly, the present inventors have completed the present invention.

### SUMMARY OF THE INVENTION

Embodiments of the present invention provide a plastic packing material which resolves the problems caused by the deficiency of compatibility between charcoal and resin such as deficiencies in mechanical properties, an aggregation phenomenon, foreign body sensation, defective forms, and poor quality, and which not only exhibits high-level general qualities such as mechanical properties and formability, but which also, as a result of containing charcoal, has functional properties such as suppressing putrefactive bacteria, absorbing polluted particles and smells, radiating far-infrared rays and anions, and preventing the generation of static electricity.

Embodiments of the present invention also provide a method for manufacturing a plastic packing material, which provides a functional plastic packing material maintaining properties as a packing material and containing charcoal in various shaped forms such as a film, a sheet and a container.

In the present invention, there is provided a method for manufacturing a plastic packing material, which controls the particle size of charcoal powder mixed with resin, the amount of charcoal power used with respect to the resin, the uniformity of the particle size according to the thickness of the plastic packing material to be formed.

Specifically, according to an aspect of the present invention, there is provided a method for manufacturing a charcoal-containing plastic packing material having a thickness of 0.01 to 0.11 mm, the method including: mixing charcoal powder at 0.2 to 1 wt % in polymer plastic resin, wherein the charcoal powder has an average diameter of 13 μm (1000 mesh) or less and a particle uniformity of 95% or more; and forming the resin-charcoal mixture as plastic having a thickness of 0.01 to 0.11 mm.

According to another aspect of the present invention, there is provided a method for manufacturing a charcoal-containing plastic packing material having a thickness of 0.12 to 2 mm, the method including: mixing charcoal powder at 1 to 5 wt % in polymer plastic resin, wherein the charcoal powder has an average diameter of 28 μm (500 mesh) or less and a particle uniformity of 90% or more; and forming the resin-charcoal mixture as plastic having a thickness of 0.12 to 2 mm.

According to still another aspect of the present invention, there is provided a method for manufacturing a charcoal-containing plastic packing material having a thickness of 2 mm or more, the method comprising: mixing charcoal powder at to 14 wt % in polymer plastic resin, wherein the charcoal powder has an average diameter of 43 μm (325 mesh) or less and a particle uniformity of 80% or more; and forming the resin-charcoal mixture as plastic having a thickness of 2 mm or more.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view magnifying an internal state of a packing material manufactured according to Manufacturing Example 1 of the present invention, and FIG. 2 is a schematic view magnifying an internal state of a packing material in which charcoal particles are not uniformly dispersed because the particle size and uniformity of the charcoal particles are not adjusted;

FIGS. 3 and 4 are graphs comparing bacteria reduction rates according to contents of charcoal in packing materials, which FIG. 3 shows a test result of a film packing material and

FIG. 4 shows a test result of a sheet packing material;

FIG. 5 is a graph comparing ammonia gas deodorizing effects according to elapsed times of a general packing material and a packing material manufactured according to the present invention;

FIG. 6 is a graph comparing ethylene gas deodorizing effects according to contents of charcoal and elapsed times in packing materials manufactured according to the present invention;

FIGS. 7 and 8 are graphs showing formation failure rates according to contents of charcoal in packing materials manufactured according to the present invention, which FIG. 7 shows a test result of a film packing material and FIG. 8 shows a test result of a sheet packing material;

FIG. 9 shows a distribution chart obtained by measuring particle sizes of charcoal powder;

FIGS. 10 to 13 are photographs magnifying surfaces states of packing materials according to a uniformity difference between charcoal powder particles, which FIGS. 10 and 11 shows photographs of a film packing material and FIGS. 12 and 13 show photographs of a sheet packing material; and

FIG. 14 is a graph showing a result obtained by testing an antistatic effect according to contents of charcoal in a packing material.

### DETAILED DESCRIPTION OF THE INVENTION

The present invention is described more fully hereinafter with reference to the accompanying drawings, in which embodiments of the present invention are shown. This present invention may, however, be embodied in many different forms and should not be construed as limited to the embodiments set forth herein. Rather, these embodiments are provided so that this disclosure is thorough, and will fully convey the scope of the present invention to those skilled in the art.

### Size of Charcoal Powder Particles

Since a large number of pores are formed in charcoal, air in the pores inside the charcoal are expanded and discharged to the outside of the charcoal as the temperature of the charcoal increases in formation (injection, extrusion, vacuum mold, pressure, coating, etc.) of the charcoal. Then, pinholes are generated, which result in poor quality and failure. In the present invention, it is considered that the reason why the pinholes are generated as described above is that the amount of air discharged from the pores of charcoal powder particles is correlated with the thickness of a product. Therefore, in order to prevent the generation of the pinholes, the size of the charcoal powder particles is changed depending on the thickness of a plastic packing material to be formed. When the thickness of the plastic packing material is 0.01 to 0.11 mm, the charcoal powder particles have an average diameter of 13 μm (1000 mesh) or less, and preferably have an average diameter of 2 to 13 μm. When the thickness of the plastic packing material is 0.23 to 3 mm, the charcoal powder particles have an average diameter of 28 μm (about 500 mesh) or less, and preferably have an average diameter of 5 to 28 μm. When the thickness of the plastic packing material is 2 mm or more, the charcoal powder particles have an average diameter of 43 μm (325 mesh) or less, and preferably have an average diameter of 10 to 43 μm.

### Content of Charcoal Powder Particles

The charcoal-containing plastic packing material does not necessarily damage the basic quality of products so as to have practicality. For example, the plastic packing material having a thickness of 0.01 to 0.11 mm may be vinyl with the shape of a film subjected to blow forming, and may be frequently used in packing food including vegetables. Vinyl packing bags used as described above basically require a considerable degree of transparency. When the content of charcoal in resin is 0.2 to 1 wt %, the visible transparency and quality of products as vinyl packing bags can be secured while maintaining functional properties of charcoal.

The plastic packing material having a thickness of 0.12 to 2 mm may be, for example, an extrusion-formed sheet product. The sheet product has a thickness thinner than that of an injection-formed product, and may be used for trays for fruit packing including a disposable food container, and the like. The sheet product can secure stable mass productivity in sheet extrusion and pressure after the sheet extrusion or coating within the range in which the content of charcoal in resin is 1 to 5 wt %. In addition, the sheet product can secure transparency which minimum contents can be seen within the range in which the content of charcoal in resin is 2.4 wt % or less.

The plastic packing material having a thickness of 2 mm or more may be, for example, an injection-formed product such as an airtight container, dustbin or separate collection container. Unlike the disposable film-type vinyl or sheet product, mechanical properties are important to the injection-formed product. The mechanical properties of the injection-formed product are tensile strength, coefficient expansion, impact strength, solidity and the like. When the content of charcoal in resin is 14 wt % or less, the problem caused by the mixture of resin with charcoal is overcome, and the injection-formed product is hardly different from the general packing material in terms of mechanical properties. Preferably, the content of charcoal in resin is 5 to 14 wt %.

### Uniformity of Charcoal Powder Particles

The uniformity of charcoal powder particles is also an important factor so as to minimize the problem caused by the mixture of charcoal with resin. In dispersion of general charcoal powder particles, it has been identified through particle size analysis that the content of corpuscles more than five times finer than the average value is about 15 wt % and the content of particles greater than the average value is about 10 wt %. The corpuscles finer than the average value remain as misty deposits on the surface of a product due to a volume variation. When a master batch for applying a color is used together with the charcoal powder, the difference in the uniformity causes a difference in color, which results in poor quality. On the other hand, the particles greater than the average value have poor quality due to foreign sensation.

When the plastic packing material requires thin thickness and visible transparency like the vinyl packing bag, foreign sensation caused by great particles is visibly exposed when the particle uniformity is lowered. Therefore, the particle uniformity in the plastic packing material having a thickness of 0.01 to 0.11 mm is necessarily 95% or more so as to prevent an aggregation phenomenon (foreign sensation) and secure mass productivity. In addition, the sheet product having a thickness of 0.12 to 2 mm, which is relatively thicker and less visible transparent as compared with than the vinyl packing material, can prevent the aggregation phenomenon (foreign sensation) and secure the stability of quality when the particle uniformity is 90% or more. In the injection-formed product having a thickness of 2 mm or more, mechanical properties are more important than transparency, and the thickness of the injection-formed product is thick. Hence the injection-formed product requires the particle uniformity less than that of the vinyl or sheet product. Preferably, the particle uniformity in the injection-formed product is 80% or more.

In the method for manufacturing the charcoal-containing plastic packing material of the present invention, a method for forming plastic by mixing charcoal power with resin may use a method of mixing charcoal powder with resin and then immediately forming plastic and a method of preparing a master batch through mixture of charcoal powder and resin and then forming plastic so that the master batch is suitable for a desired product. In the latter method, preferably, a chip-type master batch is prepared by mixing and extruding polymer plastic resin and charcoal powder using a vacuum extruder, and plastic is formed using various methods including blow forming, extrusion forming, injection forming, and the like. In the present invention, the polymer plastic resin mixed with the charcoal powder may be one selected from the group consisting of polyethylene (PE), polypropylene (PP), acrylonitrile butadiene styrene copolymer (ABS), oriented polypropylene (OPP), polyethylene terephthalate (PET), polycarbonate (PC), polystyrene (PS), polystyrene paper (PSP) and general purpose polystyrene (GPPS), or a mixture of two or more thereof.

In the present invention, the “plastic packing material” means all plastic products available for packing or accommodating regardless of shapes. For example, the plastic packing material includes a film-type vinyl packing bag, a wrap, a coating paper, a zipper bag, a sheet-type disposable or multi-use container, a tray, a fruit packing material, an airtight container, a solid plastic container, and the like.

### Embodiment

Hereinafter, the present invention will be described in detail in conjunction with exemplary embodiments. However, the embodiments are provided only for more specifically describing the present invention, and the scope of the present invention is not limited to the embodiments.

### Manufacturing Example 1

### Manufacturing of Vinyl Packing Bag

A chip-type master batch was prepared by injecting 0.5 kg charcoal powder having an average diameter of 10 μm and a particle uniformity of 97% into 100 kg polyethylene resin in a compounding machine and then mixing and extruding resin and the charcoal powder in a vacuum state. The master batch prepared as described above was formed as a film having a thickness of 0.05 mm through blow forming, and a charcoal-containing polyethylene zipper bag was manufactured by cutting the film.

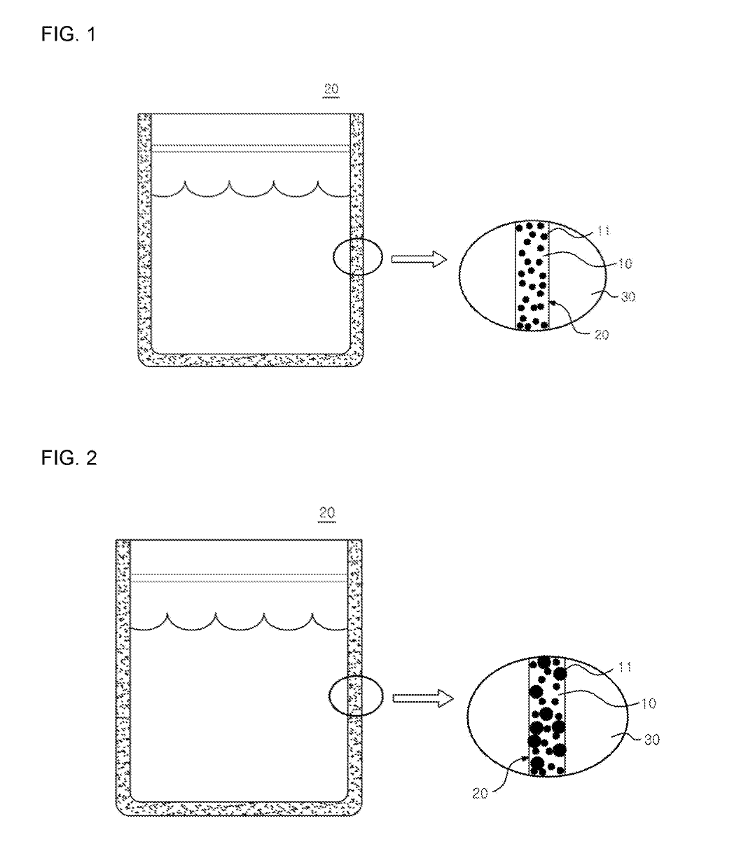

The section of the vinyl packing material (zipper bag) manufactured as described above is shown in the schematic view of FIG. 1. In the packing bag manufacture according to the present invention, the particle size and particle size dispersion of the packing bag are adjusted according to the thickness of the packing bag. Thus, charcoal particles are not protruded on the surface of the packing bag, and the surface of the packing bag can maintain a smooth state without aggregation or foreign sensation on the entire surface of the packing bag. On the other hand, FIG. 2 illustrates a state in which charcoal particles are protruded on the surface of the packing bag because the charcoal particles are not uniformly dispersed and the particle size in the packing bag is not uniform. In this state, a user is smeared with charcoal, foreign sensation occurs, and properties at a contact part between charcoal and resin is lowered. For these reasons, the vinyl packing bag cannot serve as a packing material.

### Manufacturing Example 2

### Manufacturing of Tray for Fruit Packing

A chip-type master batch was prepared by injecting 2 kg charcoal powder having an average diameter of 30 μm and a particle uniformity of 93% into 100 kg polyethylene resin in a compounding machine and then mixing and extruding resin and the charcoal powder in a vacuum state. The master batch prepared as described above was formed as a sheet having a thickness of 0.8 mm through extrusion forming, and a tray for fruit packing was manufactured by pressing the sheet.

### Manufacturing Example 3

### Manufacturing of Airtight Container

A chip-type master batch was prepared by injecting 7 kg charcoal powder having an average diameter of 35 μm and a particle uniformity of 85% into 100 kg polyethylene resin in a compounding machine and then mixing and extruding resin and the charcoal powder in a vacuum state. The master batch prepared as described above was manufactured as an airtight container having a thickness of 3 mm through injection forming.

### Experimental Example 1

### Test of Sterilizing Power

### (1) Sterilizing Power of Film

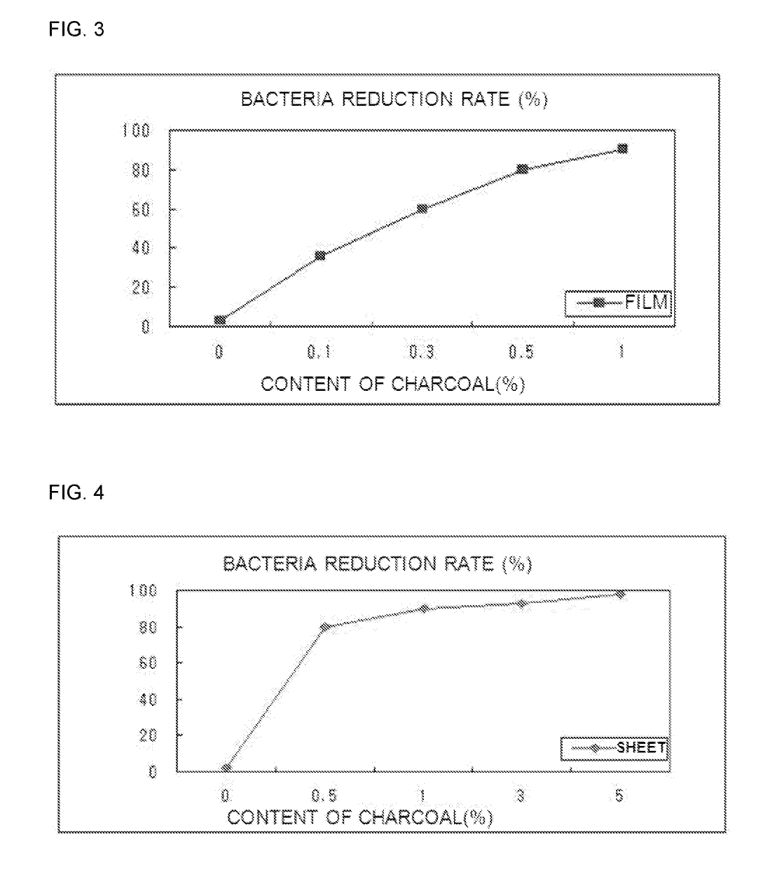

Vinyl packing bags were manufactured by varying only the contents of charcoal powder contained in the polyethylene resin as 0 wt %, 0.1 wt %, 0.3 wt % and 1 wt % under the same conditions of Manufacturing Example 1. Then, the sterilizing power according to the content of charcoal was tested for the vinyl packing bags manufactured in Experimental Example 1 together with the 0.5 wt % packing bag manufactured in Manufacturing Example 1. The bacteria reduction rate was measured using a pressure adhesion method. The number of bacteria was measured after a test bacterial solution was stationary-cultured at 25° C. for 24 hours. The sample area was set to 60 cm², and the tester strain used was Escherichia coli ATCC 25922. The result is shown in FIG. 3. The sterilizing power was 40% when 0.1% charcoal was contained in the vinyl packing bag, the sterilizing power was 81% when 0.5% charcoal was contained in the vinyl packing bag, and the sterilizing power was 93% when 1% charcoal was contained in the vinyl packing bag. Thus, as the content of charcoal powder is increased, the bacteria reduction rate is considerably increased, and the maximum sterilizing power is decreased when the content of charcoal powder is 0.5% or more. Meanwhile, as the content of charcoal powder is increased, the transparency of the vinyl packing bag is lowered, and therefore, it is difficult to identify contents in the vinyl packing bag. Accordingly, it can be decided that the content of charcoal powder is appropriately about 0.2 to 1 wt % in the resin, in consideration of the quality of the vinyl packing bags.

### (2) Sterilizing Power of Sheet

Sheets were manufactured by varying only the contents of charcoal powder contained in the polyethylene resin as 0 wt %, 0.5 wt %, 1 wt %, 3 wt % and 5 wt % under the same conditions of Manufacturing Example 2. Then, the sterilizing power according to the content of charcoal was compared and tested for the sheets manufactured in Experimental Example 1. The bacteria reduction rate was measured using a pressure adhesion technique. The number of bacteria was measured after a test bacterial solution was stationary-cultured at 25° C. for 24 hours. The sample area was set to 60 cm², and the tester strain used was Escherichia coli ATCC 25922. The result is shown in FIG. 4. Like films, the bacteria reduction rate is increased as the content of charcoal powder is increased. It can be decided that the content of charcoal powder is appropriately about 1 to 5 wt % in the resin. Meanwhile, the content of charcoal powder is increased, the transparency of the sheets is lowered, and the minimum transparency can be secured when the content of charcoal powder is 2.4 wt % or less.

### Experimental Example 2

### Test of Deodorizing Effect

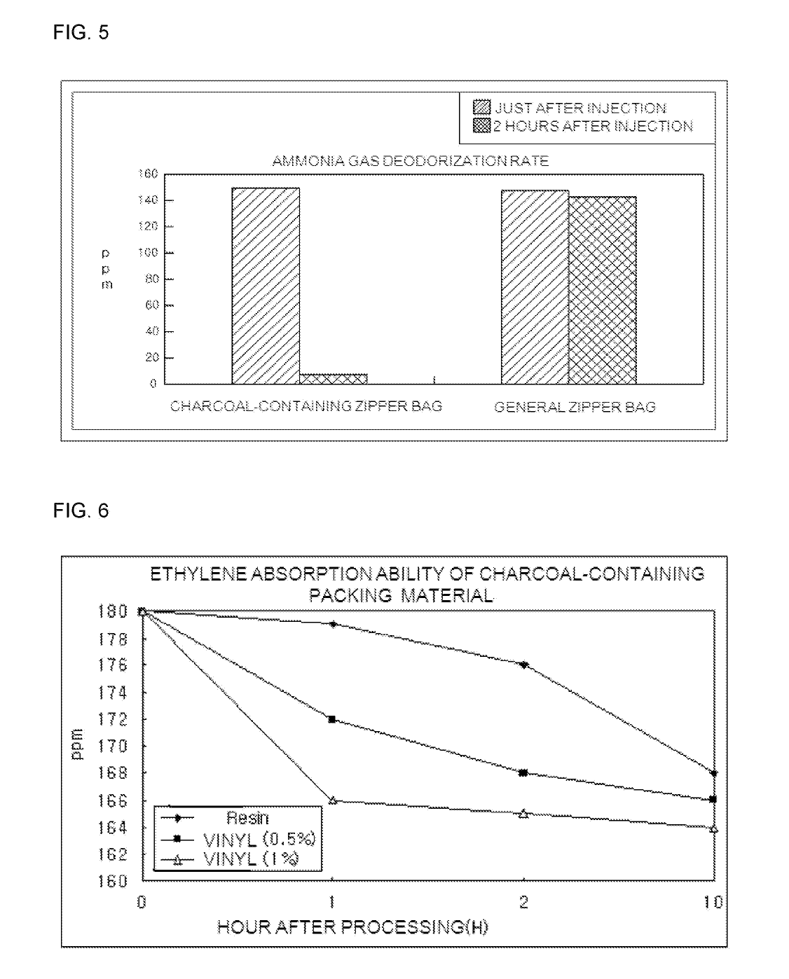

A vinyl packing bag (packing material) was manufactured by varying only the contents of charcoal powder contained in the polyethylene resin as 1 wt % under the same conditions of Manufacturing Example 1. The ammonia gas deodorizing effect of the vinyl packing bag (packing material) manufactured in Experimental Example 2 was compared with a general packing material not containing charcoal powder according to elapsed times. In the test method, the charcoal-containing packing material and the general packing material were immersed in a 5 L deodorizing container containing 150 ppm ammonia. After 120 minutes elapses, the deodorizing rate according to the elapsed time was measured using a gas detection tube method. The test result is shown in FIG. 5. As a test result, the concentration of ammonia gas in 120 minutes was 145 ppm in the general packing material, and the concentration of ammonia gas in 120 minutes was 4 ppm in the charcoal-containing packing material. The ammonia gas deodorizing rate of the charcoal-containing packing material reaches 97%, which is very advantageous. Accordingly, the charcoal-containing packing material of the present invention is very useful to remove bad smell and preserve meat.

### Experimental Example 3

### Test of Ethylene Gas Absorption Ability

Vinyl packing bags were manufactured by varying only the contents of charcoal powder contained in the polyethylene resin as 0.5 wt % and 1 wt % under the same conditions of Manufacturing Example 1. The ethylene gas absorption ability of the vinyl packing bags manufactured in Experimental Example were tested and compared with vinyl (resin) not containing charcoal powder. In order to perform the test, the vinyl (indicated as “resin”: control group) not containing charcoal powder and the two charcoal-containing packing materials (respectively containing 0.5% and 1%) were cut to have the same standard (15×5 cm) and put in 2 L airtight containers, respectively. Then, 180 ppm ethylene gas was injected into each of the containers using an injector for gas collection. Sequentially, the change in content of the ethylene gas in each of the containers was examined at a normal temperature for 10 hours. The content of the ethylene gas in each of the containers was measured using GC (Hewlett Packard 5890II). The content of the ethylene gas in each of the containers was measured by injecting 0.5 mL ethylene gas into each of the containers when the temperatures of a column oven is 200° C. and the temperature of a FID detector is 200° C. Carboxen™ 1006PLOT, 30 m 0.53 mm (SUPELCO Inc., USA) was used as the column oven. The test result is shown in FIG. 6.

The content of the ethylene gas in the control group was slightly decreased to 179 ppm in 1 hour after the ethylene gas was stored in the container. On the other hand, the content of the ethylene gas in the charcoal-containing vinyl packing bag (0.5%) was considerably decreased to 172 ppm, and the content of the ethylene gas in the charcoal-containing vinyl packing bag (1%) was considerably decreased to 166 ppm. When comparing the test result with the research paper (C. S. Jeong, S. M. Park, and W. H. Kang, 2003, Effects of charcoal-added functional paper on keeping leafy lettuce fresh during marketing, Kor. J. Hort. Sci. Technol. 21:102-105), in which when ethylene is absorbed or removed in an initial period (before/after 1 hour) having influence on the quality of a product, the long-term preservation rate of the product can be increased, the test result means that remarkably prior freshness can be obtained when the charcoal-containing packing material is used. Also, it can be identified that as the storage period is extended, the content of ethylene is considerably decreased in all the containers, which results from gas transparency of the packing material.

### Experimental Example 4

### Test of Formability According to Content of Charcoal

### (1) Formability of Film

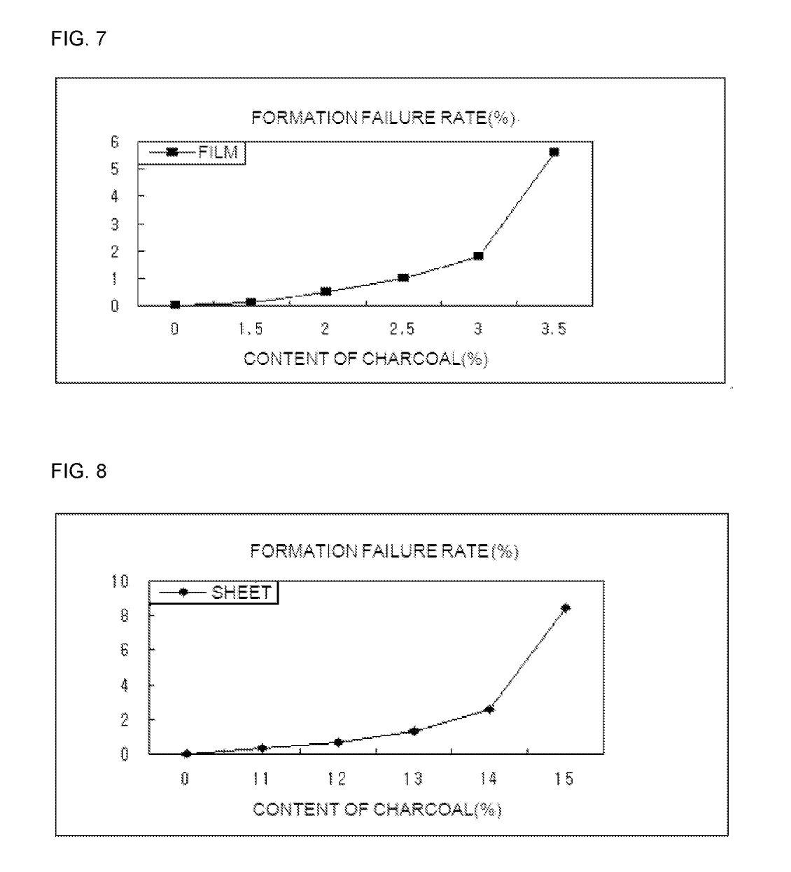

Vinyl packing bags were manufactured by varying only the contents of charcoal powder contained in the polyethylene resin as 0 wt %, 1.5 wt %, 2 wt %, 2.5 wt %, 3 wt % and 3.5 wt % under the same conditions of Manufacturing Example 1. Then, the formabilities of the vinyl packing bags manufactured in Experimental Example 4 were estimated. The test result is shown in FIG. 7. In the vinyl packing bags, the formation failure rate is 2% or less when the content of charcoal powder is 3% or less, which shows stably formability. When the content of charcoal powder is 3% or more, the formation failure rate is 8% due to the generation of pinholes, which is rapidly increased.

### (2) Formability of Sheet

Sheets were manufactured by using charcoal powder having a particle size of about 28 μm and varying only the contents of charcoal powder contained in the polyethylene resin as 0 wt %, 11 wt %, 12 wt %, 13 wt %, 14 wt % and 15 wt % under the same conditions of Manufacturing Example 2. Food containers (145×195×95 mm) having a thickness of 0.92 mm were manufactured by vacuum molding the sheets. Then, the formation failure rate according to the contents of charcoal powder was estimated with respect to the food containers. The test result is shown in FIG. 8. As the content of charcoal powder is increased, the failure rate is increased. When the content of charcoal powder is 14% or less, the failure rate is 3% or less, which shows stable formability to an extent. When the content of charcoal powder is 14% or more, the dispersion of pinholes and charcoal powder is rapidly decreased, and therefore, the failure rate approaches 10%.

In both the film and sheet, as the content of charcoal powder is increased, the properties are degraded, and the formation failure rate is increased.

### Experimental Example 5

### Test of Formability According to Uniformity of Particle Size of Charcoal Powder

### (1) Uniformity of Particle Size of Charcoal Powder

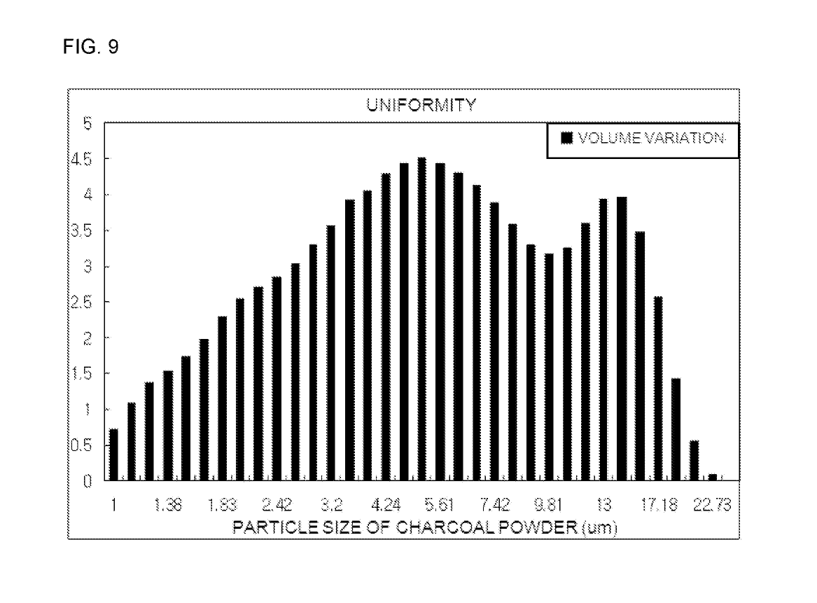

First, the uniformity the particle size of charcoal powder used as a raw material was estimated. The uniformity of charcoal powder having a particle size (diameter) of 13 μm (1000 mesh) was measured in a range from 0.4 to 20.0 μm through a dry process using an LS 13320 particle size analyzer (laser diffraction method) produced by Beckman Coulter. The test result is shown in FIG. 9, and it can be seen that the distribution of the uniformity is widely formed. When the uniformity was measured with respect to charcoal powder having average particle sizes of 43 μm (325 mesh) and 28 μm (500 mesh), it can be seen that the distribution of the uniformity is similar to that in the charcoal powder having the particle size of 13 μm (1000 mesh).

### (2) Surface State of Packing Material According to Uniformity of Particle Size of Charcoal Powder

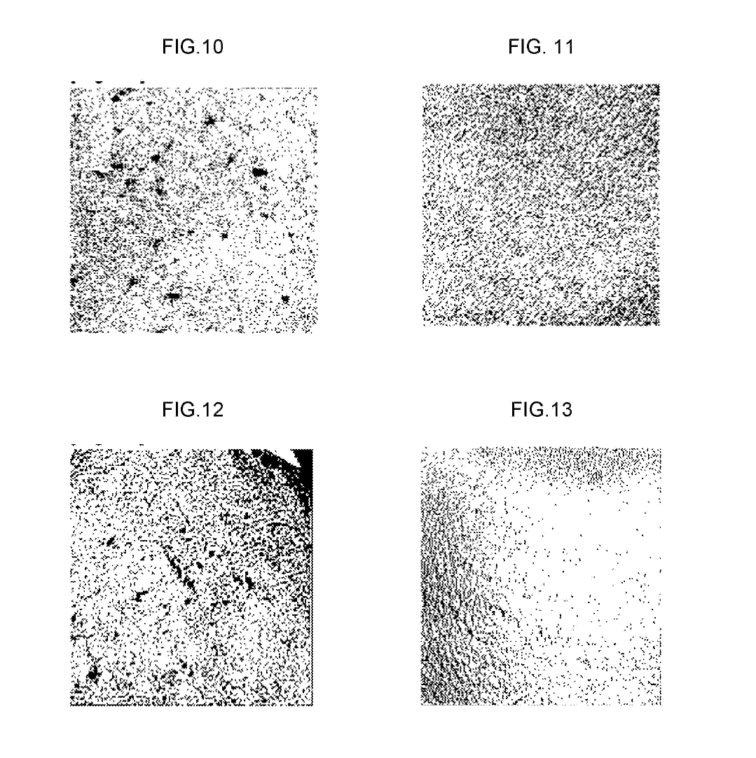

Films for packing bags were formed using charcoal powder contained in the polyethylene resin, which has a particle size of 13 μm (1000 mesh) and uniformities of 80% or less and 95% or more, under the same conditions of Manufacturing Example 1. The surfaces of the formed films are magnified and photographed, and the results are shown in FIGS. 10 and 11, respectively. When the uniformity is 80% or less, the phenomenon in which a user is smeared with charcoal appears due to coarse charcoal powder particles, and therefore, the quality of the films is considerably deteriorated. When the uniformity is 95% or more, the film has a clean surface.

In addition, sheets for packing bags were extrusion-formed using charcoal powder contained in the polyethylene resin, which has a particle size of 28 μm (500 mesh) and uniformities of 80% or less and 90% or more, under the same conditions of Manufacturing Example 2. The surfaces of the formed films are magnified and photographed, and the results are shown in FIGS. 12 and 13, respectively. When the uniformity is 80% or less, the phenomenon in which a user is smeared with charcoal appears due to coarse charcoal powder particles, and therefore, the quality of the films is considerably deteriorated. When the uniformity is 90% or more, the film has a clean surface.

(3) Various types of products were formed while varying only the uniformity of the particle size of charcoal powder contained in resin under the same average particle size, using methods including injection formation, extrusion formation, vacuum molding, blow formation, and the like. As a result, it can be seen that the foreign sensation appears in thin vinyl and sheet products according to the uniformity of the particle size of charcoal powder even under the same average particle size. The following conclusions can be obtained through the uniformity estimation.

\textcircled{1} Various vinyl products having a thickness of 0.01 to 0.11 mm are formed using charcoal powder having various particle sizes and uniformities through blow formation. As a result, when the particle size of charcoal powder is 13 μm (1000 mesh) or less, the appearance quality of the products, such as foreign sensation or aggregation phenomenon is influenced by the uniformity of charcoal powder particles. When the uniformity of charcoal powder particles is 95% or more, it is possible to secure a superior appearance quality of the product without the foreign sensation and aggregation phenomenon.

\textcircled{2} Sheet products having a thickness of 0.12 to 2 mm are formed through extrusion formation. As a result, when the particle size of charcoal powder is 28 μm (500 mesh) or more, the foreign sensation due to irregular particles cannot be removed. Therefore, the particle size of charcoal powder is set to at least 28 μm (500 mesh) or less. When the particle size of charcoal powder is 28 μm (500 mesh) or less, the appearance quality of the products, such as foreign sensation or aggregation phenomenon is influenced by the uniformity of charcoal powder particles. When the uniformity of charcoal powder particles is 90% or more, it is possible to secure a superior appearance quality of the product without the foreign sensation and aggregation phenomenon.

\textcircled{3} Products such as an airtight container, dustbin or separate collection container having a thickness of 2 mm or more are manufactured through injection formation. When the particle size of charcoal powder is 43 μm (325 mesh) or less, the commercialization of the products is possible without a particular limitation. When the uniformity of charcoal powder particles is 80% or more, it is possible to secure a superior appearance quality of the product without the foreign sensation and aggregation phenomenon due to the exposure of charcoal powder particle to the surface of the product.

### Experimental Example 6

### Test of Antistatic Effect

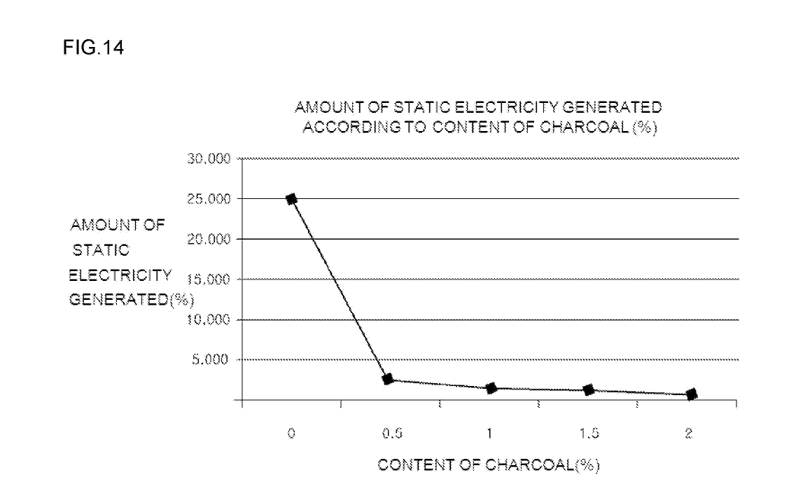

(1) Films (packing materials) were manufactured by varying only the contents of charcoal powder contained in the polyethylene resin as 0 wt %, 0.5 wt %, 1 wt %, 1.5 wt % and 2 wt % under the same conditions of Manufacturing Example 1. Then, the amount of static electricity generated was measured. The static electricity generated in the manufactured packing materials was measured under the condition of a humidity of 10%. The test result is shown in FIG. 14. It can be seen that as the content of charcoal powder is increased in the order of 0.5%, 1% and 2%, the amount of static electricity generated is gradually decreased. When the content of charcoal powder is 0.5%, the antistatic effect is superior as compared with the content of charcoal powder.

According to the present invention, there is provided a plastic packing material which resolves the problems caused by the deficiency of compatibility between charcoal and resin such as deficiencies in mechanical properties, an aggregation phenomenon (foreign body sensation), defective forms, and poor quality, and maintains the general properties of the plastic packing material and quality of products in terms of mechanical properties, formability, surface state, and the like. The packing material of the present invention has functional properties such as suppressing putrefactive bacteria, absorbing polluted particles and smells, radiating far-infrared rays and anions, and preventing the generation of static electricity, so that it is possible to remarkably reduce bad smell and ammonia gas generated from food and to delay the speed of decay. Also, the plastic packing material of the present invention can be used as a functional packing material (tray, etc.) for controlling ripeness of fruits such as apples and pears and maintaining freshness by absorbing ethylene gas generated from fruits. Since the problem of static electricity is resolved by containing charcoal powder in the plastic packing material, the plastic packing material of the present invention can be used as a vinyl packing material for automatic packing, which has a perfect antistatic function, while substituting for general vinyl packing materials.

Although a few embodiments of the present invention have been shown and described, it would be appreciated by those skilled in the art that changes may be made in this embodiment without departing from the principles and spirit of the invention, the scope of which is defined in the claims and their equivalents.

1. A method for manufacturing a charcoal-containing plastic packing material having a thickness of 0.01 to 0.11 mm, the method comprising:
mixing charcoal powder at 0.2 to 1 wt % in polymer plastic resin, wherein the charcoal powder has an average diameter of 13 μm (1000 mesh) or less and a particle uniformity of 95% or more; and
forming the resin-charcoal mixture as plastic having a thickness of 0.01 to 0.11 mm.

2. The method of claim 1, wherein the resin-charcoal mixture is blow-formed in a film shape.

3. A method for manufacturing a charcoal-containing plastic packing material having a thickness of 0.12 to 2 mm, the method comprising:
mixing charcoal powder at 1 to 5 wt % in polymer plastic resin, wherein the charcoal powder has an average diameter of 28 μm (500 mesh) or less and a particle uniformity of 90% or more; and
forming the resin-charcoal mixture as plastic having a thickness of 0.12 to 2 mm.

4. The method of claim 3, wherein the resin-charcoal mixture is extrusion-formed in a sheet shape.

5. A method for manufacturing a charcoal-containing plastic packing material having a thickness of 2 mm or more, the method comprising:
mixing charcoal powder at 1 to 14 wt % in polymer plastic resin, wherein the charcoal powder has an average diameter of 43 μm (325 mesh) or less and a particle uniformity of 80% or more; and
forming the resin-charcoal mixture as plastic having a thickness of 2 mm or more.

6. The method of claim 5, wherein the resin-charcoal mixture is injection-formed.

7. The method of claim 1, wherein the mixing comprises preparing a chip-type master batch by mixing and extruding the charcoal powder in the polymer plastic resin.

8. The method of claim 7, wherein the polymer plastic resin comprises at least one selected from the group consisting of polyethylene (PE), polypropylene (PP), acrylonitrile butadiene styrene copolymer (ABS), oriented polypropylene (OPP), polyethylene terephthalate (PET), polycarbonate (PC), polystyrene (PS), polystyrene paper (PSP) and general purpose polystyrene (GPPS).

9. The method of claim 3, wherein the mixing step comprises preparing a chip-type master batch by mixing and extruding the charcoal powder in the polymer plastic resin.

10. The method of claim 5, wherein the mixing step comprises preparing a chip-type master batch by mixing and extruding the charcoal powder in the polymer plastic resin.
